(19) United States
(12) Patent Application Publication
(10) Pub. No.: US 2007/0083427 A1
(43) Pub. Date: Apr. 12, 2007

(54) System and method for evaluating redemption value of incentive award points

(76) Inventor: Robert B. Morgan, St. Petersburg, FL (US)

Correspondence Address: SHUMAKER LOOP & KENDRICK, 101 E. KENNEDY, SUITE 2800, TAMPA, FL, 33672-0609, US

(21) Appl. No.: 11/246,986

(22) Filed: Oct. 7, 2005

(51) Int. Cl. G06Q 30/00

(52) U.S. Cl. 705/14

(57) ABSTRACT

A system and method for effectively analyzing points received in incentive points program and how to best use those points. Such incentive points programs include, for example, credit cards and airline reward programs that accrue points, which in turn can be redeemed for various products and services.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Technical Field

This invention relates to incentive award points programs, and more particularly, to systems and methods of evaluating the purchase power of incentive award points earned in incentive award point programs.

2. Background Information

Incentive point programs are well-known in the prior art. In general, such programs are administered by banks or other lending institutions that provide participants a credit card. Credit cards are a type of credit instrument that allow participants to buy products and/or services by drawing against their established credit line and repaying the credit card issuing institution that advances the credit. If an individual using a credit card is unable to repay the full amount utilized at the time of account settlement, they must typically pay back the owed amount to the issuing credit card institution along with a percent or fee charged on the amount owed.

Credit card issuing institutions have established incentive award programs to increase credit card usage. Incentive award programs typically encourage or reward the participant for use of a specific credit card or particular merchants that sell goods and/or services. Such programs are also referred to as loyalty, frequency, affinity, retention, or performance improving programs. This is because such programs encourage or improve participant loyalty, affinity, retention, quality of performance, or frequency of performance.

Incentive award programs reward participants with points that can be redeemed for motivational reward products and/or services from authorized merchants who are part of the incentive award program. As a result of the widespread acceptance of incentive award programs, countless consumer products and/or services can now be redeemed with points earned in such programs. Common examples include airline travel tickets, electronics, furniture, and a vast variety of consumer products and services.

Incentive award programs, however, have drawbacks for participants. In general, the management of points earned in incentive award programs has become quite complicated. For example, the available rewards for a particular incentive program may be provided at differing values to the participant. That is, the number of points charged for a first product having a particular retail cash value may differ significantly compared to the number of points required for a different product or service having an identical retail cash value to the first product. For example, a chair having a retail cash value of $100 may cost a participant 13,000 points whereas a television having a retail cash value of $100 may cost a participant 9,000 points. Also, the fact that most rewards have different retail cash values makes determining relative value that much more difficult for participants.

### BRIEF SUMMARY

It is therefore an object of the present invention to resolve or improve upon one or more of the above-described drawbacks. This object is obtained by providing a system and method, facilitated by a computer processor, of analyzing and managing the redemption of points in an incentive award program.

The method includes the steps of inputting into a computer processor a predetermined goal, the goal being a desired cash amount to be received per a predetermined number of points. Once the goal is input, a participant inputs a predetermined point value for a desired reward and the retail cash value for the reward. The computer processor then determines the actual point value of the points required for the first reward relative to the predetermined goal. Based on the actual point value and the predetermined goal, the computer processor then computes a recommendation, such as a “Buy” or “No Buy” signal. A participant can also input and compare numerous rewards, including the dollar difference and the percent difference between the actual point value and the point value goal.

In another aspect of the present invention, a participant can also track the cumulative point cost of multiple rewards- and the difference between the number of total earned points and the points remaining after allocation to the rewards.

In yet another aspect of the present invention, the system and method also provides the participant with the actual cash value per a predetermined number of points required for a reward.

In yet another aspect of the present invention, the system and method also provides the participant with the difference between the retail cash value of a specific reward and the cash value necessary for the reward to meet the predetermined goal.

In yet another aspect of the present invention, the system is resident on a website and is accessible via the World Wide Web.

In yet another aspect of the present invention, the system is downloadable via the internet from a host website.

### BRIEF DESCRIPTION OF THE DRAWINGS

FIG. 1 is a flow chart of one embodiment of the present invention;

FIG. 2 is a flow chart of one embodiment of the present invention; and

FIG. 3 is a table illustrating one embodiment of the present invention.

### DETAILED DESCRIPTION OF THE DRAWINGS AND THE PRESENTLY PREFERRED EMBODIMENTS

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings. It should also be understood that the drawings are not to scale and in certain instances details have been omitted, which are not necessary for an understanding of the present invention, such as conventional programming details that are apparent to one of ordinary skill in the art.

Definitions:

Incentive Award Point: a quantitative benefit provided to participants in incentive award programs in exchange for a participant's use of a credit card or performance of other incentivized behaviors, e.g., signing up for the incentive award program, online purchases, etc.; incentive award points are redeemable for rewards; incentive award points include, among other things, airline miles, airline points and other similar redeemable benefits provided as a quid pro quo for performance of an incentivized behavior.

Reward: product(s), service(s), coupon(s), gift card(s), gift certificate(s), other points, cash, or the like that can be redeemed with incentive award points.

Retail Cash Value: the monetary worth of a reward as sold directly to a consumer or participant.

Points Required: the number of points required to redeem a reward.

Actual Point Value or Purchase Power Value: the resulting ratio of retail cash value divided by the result of incentive award points divided by 100.

Goal: the ratio of cash to incentive award points that is desired by a participant when redeeming incentive award points for rewards.

Point Value Goal: retail value of points based on the goal; points required divided by the result of 100 times the goal per 100 points.

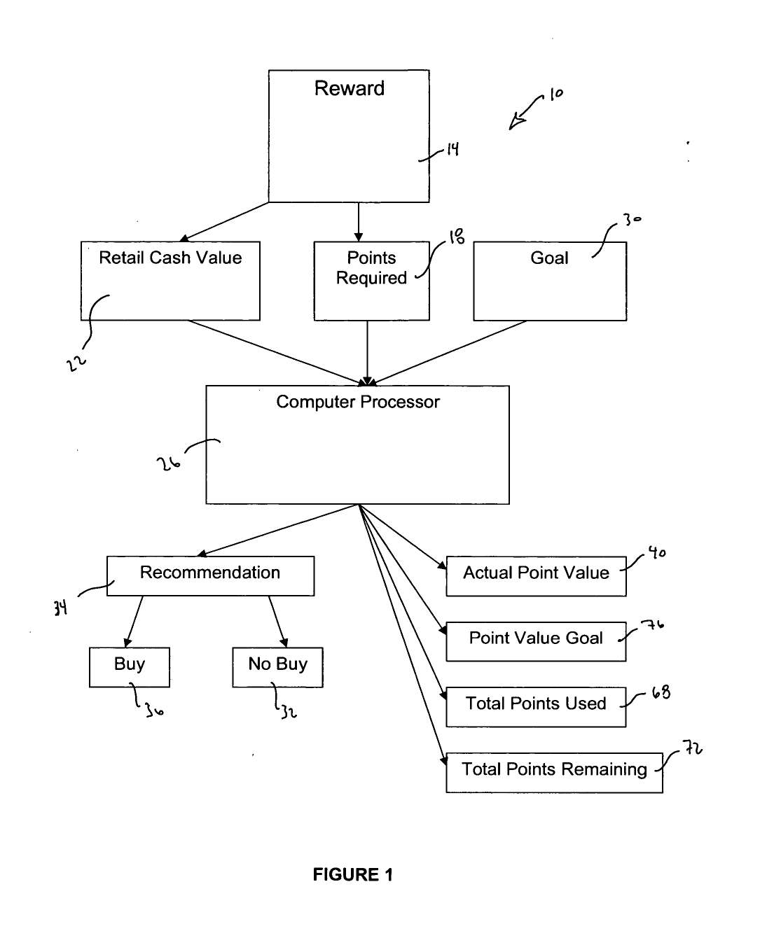

Referring to the drawings, FIGS. 1-3 illustrate a first embodiment of the present invention, and in particular, a system and method 10 of evaluating the purchase power of incentive award points earned in incentive point programs. In general, the system and method 10 includes a reward 14 having a retail cash value 22 and a points requirement 18. The retail cash value 22, the points required 18, and the goal 30 are input into computer processor 26. Computer processor 26 then calculates the actual point value 40 for reward 14. Based on the goal, the computer processor 26 can then provide a recommendation signal 34 such as “buy” signal 36 or “no buy” signal 32. The system and method 10 can be used to evaluate practically limitless numbers of rewards, thus allowing a participant to quickly analyze whether the reward(s) meet the participant's predetermined goal. The system and method 10 further allows a participant to compare multiple rewards to each other and track the total number of incentive points necessary to redeem multiple rewards.

FIG. 1 illustrates a system and method 10 of evaluating the purchase power of incentive award points earned in incentive programs. As illustrated, a particular reward 14 is selected by a participant. This reward has a retail cash value 22 and a points requirement 18. Both retail cash value 22 and points required 18 are input into the computer processor 26. In addition, a goal 30 (as described above) is also input into computer processor 26. Computer processor 26 is provided with a software program that can carry out the requisite computations. One exemplary program is Microsoft Excel, which is available through a wide variety of well-known software providers. Moreover, in view of the present disclosure, one of ordinary skill in the art will be able to create a wide variety of programs that can carry out the computations disclosed herein.

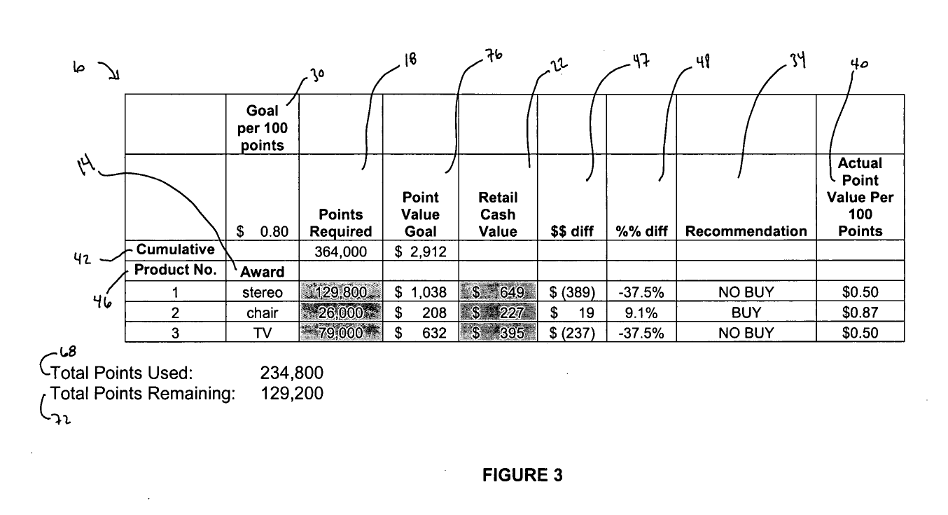

When retail cash value 22, points required 18, and goal 30 are input into computer processor 26, the computer processor generates one or more results. For example, computer processor 26 can generate actual point value 40 and/or point value goal 76. In addition, when analyzing a plurality of rewards, the computer processor can optionally generate the total points used 68. Similarly, the computer processor can also generate the total points remaining 72 out of a cumulative points available 42 to the participant, as illustrated in FIGS. 1 and 3.

Additionally, as illustrated in FIG. 1, the computer processor also generates a recommendation 34 based on the retail cash value 22, the points required 18, and the goal 30. In particular, when the actual point value 40 is greater than or equal to the goal 30, the computer processor 26 generates a positive recommendation, such as “Buy.” Conversely, when the actual point value 40 is less than goal 30, computer processor 26 generates a negative recommendation, such as “No Buy.”

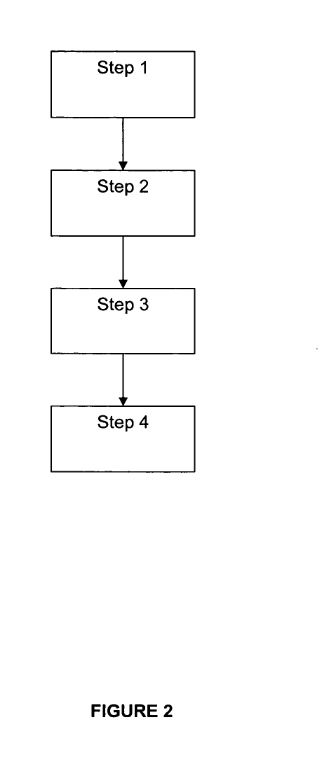

In use, a participant first determines a goal per 100 points and inputs this value into the computer processor, as illustrated at step 1 of FIG. 2. Next, the participant selects a desired reward and determines the retail cash value of the reward along with the point value of the reward. The retail cash value and the points required for the reward are input into the computer processor in step 2 of FIG. 2. Based on these values, in step 3 of FIG. 2, the computer processor computes the actual point value and the point value goal. In step 4 of FIG. 2, the computer generates a recommendation (e.g., Buy 36 or No Buy 32 as shown in FIG. 1), as described above with respect to FIG. 1. As a result, a participant can quickly determine whether any number of rewards meet the participant's goal. The participant can also see the value realized from the points by redeeming the points for the selected reward. Moreover, when multiple rewards are analyzed by the computer processor, the participant can compare the value realized by using points for one reward versus a different reward. Accordingly, a participant can evaluate and select awards having the greatest value. Put differently, the participant can make an informed redemption decision.

The system and method of the present invention can be made accessible to participants via a network such as the World Wide Web. In particular, a program that performs the necessary computations can be provided for direct use on a web page or alternatively for downloading from a webpage. Similarly, the program can be provided on a separate media, such as a CD-ROM or other media that are commonly used and are apparent to one of ordinary skill in the art.

### EXAMPLE

FIG. 3 illustrates one embodiment of the present invention in which a programmed computer processor is used to perform the above-described computations. In the example of FIG. 3, a user inputs the goal, which in this case is $0.80 per 100 points. The user can optionally enter the cumulative number of points (row 42), which in this case is 364,000 points. When the goal is $0.80 per 100 points, the point value goal is $2,912 for 364,000 points. The point value goal of $2,912 for 364,000 points thus equals 364,000 points/100×$0.80.

Likewise, FIG. 3 illustrates a use of the present invention to determine the actual point value of points redeemed for a stereo, a chair, and a TV. As shown, the retail cash value of stereo is $649. The retail cash value is input by the participant. The points required for the stereo is 129,800 points, which is also input by the participant. Based on the goal of $0.80 per 100 points, the retail cash value, and the point value, the computer processor computes a point value goal of $1,038 (column 76), that is, 129,000 points/100*$0.80. Thus, there is a difference of $389.00 (see column 47) or 37.5% between the point value goal and the retail cash value. In addition, the computer processor computes an actual point value of $0.50 per 100 points for the stereo, which is far below the goal of $0.80 per 100 points. Since the goal is not met, a recommendation (column 34) of “No Buy” is generated for the stereo. For the same reason, the TV also generates a recommendation of “No Buy.” The chair, however, generates a recommendation of “Buy” because the actual point value is greater than the goal of $0.80 per 100 points.

Of course, as will become apparent to one of ordinary skill in the art in view of this disclosure, the present system and method does not require that a goal be set. Rather, the method and system can be used specifically to determine the actual point value for one or more rewards.

Using the method and system of the present invention, a participant can therefore more effectively and efficiently individually analyze rewards and/or compare numerous rewards and the actual point value received for such rewards. In addition, a user can track the cumulative points potentially redeemed for multiple rewards. This results in improved purchasing power and more informed decision making on the part of the participant.

It is intended that the foregoing detailed description be regarded as illustrative rather than limiting, and that it be understood that it is the following claims, including all equivalents, that are intended to define the spirit and scope of this invention.

1. A method, facilitated by a computer for receiving and processing
data, of evaluating points earned in an incentive award program, the incentive award program permitting the participants to redeem points for rewards, the method comprising the steps of:
a. receiving first input data identifying a first reward;
b. receiving second input data identifying a point requirement for the first reward;
c. receiving a third input data identifying a retail cash value for the first reward;
d. computing the actual point value of the first reward; and
e. displaying the actual point value of the first reward.

2. The method of claim 1, further comprising the steps of:
f. receiving a fourth input data identifying a goal, the goal comprising a desired cash amount to be received for a predetermined number of points;
g. computing the point value goal of the first reward; and
h. displaying the point value goal of the first reward.

3. The method of claim 2, further comprising the steps of:
i. computing a positive recommendation signal when the actual point value of the first reward is one of greater than or equal to the goal; and
j. displaying the signal.

4. The method of claim 3, further comprising the step of:
k. computing a negative recommendation signal when the actual point value of the first reward is less than the goal; and
l. displaying the signal.

5. The method of claim 1, further comprising the steps of:
e. receiving a fourth input data identifying a second reward;
f. receiving a fifth input data identifying a point requirement for the second reward;
g. receiving a sixth input data identifying a retail cash value for the second reward;
h. computing the actual point value of the second reward; and
i. displaying the actual point value of the second reward.

6. The method of claim 5, further comprising the step of comparing the actual point value of the first reward and the actual point value of the second reward.

7. The method of claim 6, further comprising the steps of computing a cumulative point cost of the first reward and the second reward; and displaying the cumulative point cost.

8. The method of claim 6 further comprising the steps of determining a cash difference between the point value goal and the actual point value; and displaying the cash difference.

9. The method of claim 6, further comprising the steps of determining a percent difference between the point value goal and the actual point value; and displaying the percent difference.

10. The method of claim 1, further comprising the step of providing a network, wherein the predetermined goal, the predetermined point requirement, and the retail cash value are input into the computer processor via the network.

11. The method of claim 8, wherein the network comprises the World Wide Web.

12. A system for analyzing points earned in an incentive award program, the incentive award program permitting a participant to redeem points for rewards having a retail cash value and a point requirement, the system comprising a computer processor programmed to evaluate the actual point value of the rewards.
